(19) United States
(12) Patent Application Publication
(10) Pub. No.: US 2025/0323267 A1
(43) Pub. Date: Oct. 16, 2025

(54) BINDERS FOR NON-AQUEOUS ELECTROLYTE RECHARGEABLE BATTERIES, BINDER COMPOSITIONS, NEGATIVE ELECTRODE SLURRIES, NEGATIVE ELECTRODES, NON-AQUEOUS ELECTROLYTE RECHARGEABLE BATTERIES, AND METHODS FOR PREPARING BINDER FOR NON-AQUEOUS ELECTROLYTE RECHARGEABLE BATTERIES

(71) Applicant: SAMSUNG SDI CO., LTD., Yongin-si (KR)

(72) Inventors: Tomoyuki FUKATANI, Yokohama-shi (JP); Hyunhee SHIM, Yokohama-shi (JP)

(21) Appl. No.: 19/177,260

(22) Filed: Apr. 11, 2025

(30) Foreign Application Priority Data
Apr. 15, 2024 (JP) 2024-065727

(51) Int. Cl. H01M 4/62; C08F 20/18; H01M 4/02; H01M 4/13

(52) U.S. Cl. CPC H01M 4/622; C08F 20/18; H01M 4/13; H01M 2004/027

(57) ABSTRACT

A binder for the non-aqueous electrolyte rechargeable battery includes a particle-shaped binder having a core-shell structure including a hydrophobic core and a hydrophilic shell. The hydrophobic core includes at least one selected from among a derivative from an aromatic vinyl monomer, a derivative from an unsaturated carboxylic acid alkyl ester monomer, a derivative from a (meth)acrylic acid monomer, and a derivative from an unsaturated carboxylic acid amide monomer. The hydrophilic shell includes a derivative from a (meth)acrylic acid monomer, a derivative from a sodium styrene sulfonate monomer, and a derivative from a (meth)acrylonitrile monomer. An amount of the hydrophobic core is greater than or equal to about 90 wt % and less than or equal to about 97 wt %, and an amount of the hydrophilic shell is greater than or equal to about 3 wt % and less than or equal to about 10 wt % based on 100 wt % of the binder.

### CROSS-REFERENCE TO RELATED APPLICATION

The present application claims priority to and the benefit of Japanese Patent Application No. 2024-065727, filed on Apr. 15, 2024, in the Japan Patent Office, the entire content of which is incorporated herein by reference.

### BACKGROUND

### 1. Field

The present disclosure relates to a binder for a non-aqueous electrolyte rechargeable battery, a binder composition for a non-aqueous electrolyte rechargeable battery, a negative electrode slurry for a non-aqueous electrolyte rechargeable battery including the binder and/or the binder composition, a negative electrode for a non-aqueous electrolyte rechargeable battery formed utilizing the negative electrode slurry, and a non-aqueous electrolyte rechargeable battery including the negative electrode.

### 2. Description of the Related Art

Lithium-ion batteries, which are also referred as non-aqueous electrolyte rechargeable batteries, have high energy density and are widely utilized in mobile batteries, personal computers, and/or automobiles. With the recent increase in utilization, the market is increasingly demanding rapid charging, and there is a strong demand for higher output and reduced internal resistance for lithium-ion batteries.

Therefore, it is proposed (Proposal 1) to reduce internal resistance by utilizing a water-dispersed binder mainly composed of 2-ethylhexyl acrylic acid and styrene, which is synthesized by emulsion polymerization utilizing a low-molecular-weight surfactant. For example, U.S. Pat. No. 6,007,263, describes such a binder, the entire content of which is incorporated herein by reference.

However, if (e.g., when) the water-dispersed binder described in the Proposal 1 is utilized, the peel strength between the electrode mixture layer and the current collector is not sufficient. As a result, a portion of the electrode mixture layer may peel off from the current collector during the process of cutting the electrode to a predetermined size, or there is a risk that dust from the electrode mixture layer may fall off during the process of transporting the electrode at high speed using a roll.

### SUMMARY

The present disclosure has been made in consideration of the above-mentioned problems, and provides a binder for a non-aqueous electrolyte rechargeable battery which has enhanced adhesion (e.g., excellent or suitable adhesion) between an electrode mixture layer and a current collector (e.g., peel strength of the electrode) and which may reduce the internal resistance of the battery more than before.

For example, the binder, binder composition, a negative electrode slurry, a negative electrode, a rechargeable battery, and a method for manufacturing the binder according to the present disclosure are described and/or illustrated as follows.

Additional aspects will be set forth in part in the description which follows and, in part, will be apparent from the description, or may be learned by practice of the presented embodiments of the disclosure.

According to one or more embodiments, a binder for a non-aqueous electrolyte rechargeable battery may include a particle-shaped binder having a core-shell structure including a hydrophobic core and a hydrophilic shell, where the hydrophobic core includes at least one selected from among a derivative from an aromatic vinyl monomer, a derivative from an unsaturated carboxylic acid alkyl ester monomer, a derivative from a (meth)acrylic acid monomer, and a derivative from an unsaturated carboxylic acid amide monomer, and the hydrophilic shell includes at least one selected from among a derivative from a (meth)acrylic acid monomer, a derivative from a sodium styrene sulfonate monomer, and/or a derivative from a (meth)acrylonitrile monomer.

In one or more embodiments, a content (e.g., amount) of the hydrophobic core is greater than or equal to about 90 wt % and less than or equal to about 97 wt %, and a content (e.g., amount) of the hydrophilic shell is greater than or equal to about 3 wt % and less than or equal to about 10 wt % based on 100 wt % of the binder, and an average particle size of the binder measured by a wet laser diffraction scattering method is greater than or equal to about 250 nm and less than or equal to about 1000 nm.

In one or more embodiments, the hydrophilic shell is formed by a water-soluble polymer.

In one or more embodiments, the water-soluble polymer includes the derivative from the (meth)acrylic acid monomer, the derivative from the sodium styrene sulfonate monomer, and/or the derivative from a (meth)acrylonitrile monomer. In the water-soluble polymer, a content (e.g., amount) of the derivative from the (meth)acrylic acid monomer may be greater than or equal to about 10 wt % and less than or equal to about 50 wt %, a content (e.g., amount) of the derivative from the sodium styrene sulfonate monomer may be greater than or equal to about 10 wt % and less than or equal to about 50 wt %, and a content (e.g., amount) of the derivative from the (meth)acrylonitrile monomer unit may be greater than or equal to about 10 wt % and less than or equal to about 50 wt %, based on 100 wt % of the water-soluble polymer.

In one or more embodiments, a molecular weight (weight average molecular weight) of the water-soluble polymer is about 300,000 to about 2,000,000.

In one or more embodiments, the hydrophobic core is formed from a hydrophobic polymer including the derivative from an aromatic vinyl monomer, a derivative from an unsaturated carboxylic acid alkyl ester monomer, the derivative from a (meth)acrylic acid monomer, and/or the derivative from an unsaturated carboxylic acid amide monomer.

In one or more embodiments, the hydrophobic core and the hydrophilic shell are chemically bonded to each other (e.g., the hydrophobic core is chemically bonded to the hydrophilic shell).

In one or more embodiments, a non-reactive surfactant is not added.

According to one or more embodiments, a binder composition for a non-aqueous electrolyte rechargeable battery may include a binder for a non-aqueous electrolyte rechargeable battery as described herein and an aqueous solvent.

According to one or more embodiments, a negative electrode slurry for a non-aqueous electrolyte rechargeable battery may include the binder composition for the non-aqueous electrolyte rechargeable battery as described herein and a negative electrode active material.

According to one or more embodiments, a negative electrode for a non-aqueous electrolyte rechargeable battery may include the binder for the non-aqueous electrolyte rechargeable battery as described herein and a negative electrode active material.

In one or more embodiments, the negative electrode further includes a water-soluble polymer compound.

In one or more embodiments, the water-soluble polymer compound is an alkali metal salt of carboxymethyl cellulose.

According to one or more embodiments, a non-aqueous electrolyte rechargeable battery may include a negative electrode as described herein.

According to one or more embodiments, a method for preparing a binder for a non-aqueous electrolyte rechargeable battery may include preparing a particle-shaped binder having a core-shell structure including a hydrophobic core and a hydrophilic shell, synthesizing a hydrophobic polymer constituting the hydrophobic core in the presence of a water-soluble polymer constituting the hydrophilic shell.

In one or more embodiments, the water-soluble polymer includes a derivative from a (meth)acrylic acid monomer, a derivative from a sodium styrene sulfonate monomer, and/or a derivative from a (meth)acrylonitrile monomer.

In one or more embodiments, the hydrophobic polymer is composed by polymerization of one or more monomers selected from among an aromatic vinyl monomer, an unsaturated carboxylic acid alkyl ester monomer, a (meth)acrylic acid monomer, and/or an unsaturated carboxylic acid amide monomer.

In one or more embodiments, a content (e.g., amount) of the hydrophobic core is greater than or equal to about 90 wt % and less than or equal to about 97 wt %, and a content (e.g., amount) of the hydrophilic shell is greater than or equal to about 3 wt % and less than or equal to about 10 wt %, based on 100 wt % of the binder.

In one or more embodiments, an average particle size of the binder measured by a wet laser diffraction scattering method is greater than or equal to about 250 nm and less than or equal to about 1000 nm.

According to the present disclosure, the binder of the present disclosure provides a particle-shaped binder which has a core-shell structure including a hydrophobic core and a hydrophilic shell to improve the adhesion between an electrode mixture layer and a current collector of the non-aqueous electrolyte rechargeable battery. Therefore, it is possible to provide a non-aqueous electrolyte rechargeable battery having excellent or suitable adhesion between the electrode mixture layer and the current collector, and further capable of reducing the internal resistance of the non-aqueous electrolyte rechargeable battery.

For example, according to the present disclosure, a binder for a non-aqueous electrolyte rechargeable battery includes a particle-shaped binder with a core-shell structure, featuring a hydrophobic core and a hydrophilic shell. The hydrophobic core includes derivatives from various monomers such as aromatic vinyl, unsaturated carboxylic acid alkyl ester, (meth)acrylic acid, and/or unsaturated carboxylic acid amide monomers. The hydrophilic shell includes derivatives from (meth)acrylic acid, sodium styrene sulfonate, and/or (meth)acrylonitrile monomers. The binder composition aims to enhance adhesion between the electrode mixture layer and the current collector, thereby reducing the internal resistance of the battery. The hydrophobic core constitutes 90-97 wt % of the binder, while the hydrophilic shell makes up 3-10 wt %. The average particle size of the binder ranges from 250 nm to 1000 nm. This core-shell structure improves the adhesion between the electrode mixture layer and the current collector, providing a non-aqueous electrolyte rechargeable battery with enhanced adhesion and reduced internal resistance.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, serve to explain principles of the present disclosure. In the drawings:

The drawing is a schematic view illustrating a non-aqueous electrolyte rechargeable battery according to one or more embodiments of the present disclosure.

### DETAILED DESCRIPTION

Hereinafter, one or more embodiments will be described in more detail so that those of ordinary skill in the art may implement them. However, the present disclosure may be embodied in many different forms and is not construed as limited to one or more embodiments set forth herein.

In this description, it will be understood that, if (e.g., when) an element or component is referred to as being on another element, the element or component may be directly on the other element, or intervening elements may be present therebetween. In contrast, if (e.g., when) an element is referred to as being “directly on” another element, there are no intervening elements present. In the drawings, thicknesses of some components are exaggerated for effectively explaining the technical contents. Like reference numerals refer to like elements throughout, and duplicative descriptions thereof may not be provided the specification.

The terminology utilized herein is utilized to describe one or more embodiments only, and is not intended to limit the present disclosure. The singular expression includes the plural expression unless the context clearly dictates otherwise.

As utilized herein, “combination thereof” refers to a mixture, a laminate, a composite, a copolymer, an alloy, a blend, a reaction product, and/or the like of the constituents.

Here, it should be understood that terms such as “comprise/comprises/comprising,” “include/includes/including,” or “have/has/having” are intended to designate the presence of an embodied feature, number, step (e.g., act or task), element, and/or a (e.g., any suitable) combination thereof, but it does not preclude the possibility of the presence or addition of one or more other features, number, step (e.g., act or task), element, and/or a (e.g., any suitable) combination thereof. For example, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In the drawings, the thickness of layers, films, panels, regions, and/or the like., are exaggerated for clarity and like reference numerals designate like elements throughout, and duplicative descriptions thereof may not be provided in the specification. It will be understood that if (e.g., when) an element such as a layer, film, region, or substrate is referred to as being “on” another element, it may be directly on the other element or intervening elements may also be present. In contrast, if (e.g., when) an element is referred to as being “directly on” another element, there are no intervening elements present.

In addition, “layer” herein includes not only a shape formed on the whole surface if (e.g., when) viewed from a plan view, but also a shape formed on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical or physical properties of the binder.

Further, in this specification, the phrase “on a plane,” or “plan view,” indicates viewing a target portion from the top, and the phrase “on a cross-section” indicates viewing a cross-section formed by vertically cutting a target portion from the side.

The term “particle diameter”, “particle size”, and/or the like as utilized herein refers to an average diameter of particles if (e.g., when) the particles are spherical, and refers to an average major axis length of particles if (e.g., when) the particles are non-spherical. For example, a particle diameter (size) may be an average particle diameter (size). In some embodiments, a particle diameter (size) indicates an average particle diameter (size) (D₅₀) where a cumulative volume is about 50 volume % in a particle size distribution. The average particle diameter (size) (D₅₀) may be measured by a method widely suitable to those skilled in the art, for example, by a particle size analyzer, a transmission electron microscope (TEM) image, or a scanning electron microscope (SEM) image. In one or more embodiments, a dynamic light-scattering measurement device is used to perform a data analysis, the number of particles is counted for each particle size range, and then from this, an average particle diameter (size) (D₅₀) value may be obtained through a calculation. Dissimilarly, a laser scattering method may be utilized to measure the average particle diameter (size) (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (size) (D₅₀) is calculated in the 50% standard of particle diameter (size) distribution in the measurement device.

Here, “or” is not to be construed as an exclusive meaning, for example, “A or B” is construed to include A, B, A+B, and/or the like.

“Metal” is interpreted as a concept including ordinary metals, transition metals and metalloids (semi-metals).

Hereinafter, a configuration of a rechargeable battery according to one or more embodiments is described.

### 1. Non-Aqueous Electrolyte Rechargeable Battery

A rechargeable lithium-ion battery according to one or more embodiments includes a positive electrode, a negative electrode, a separator, and a non-aqueous electrolyte. The charging reached voltage (oxidation-reduction potential) of this rechargeable lithium-ion battery may be greater than or equal to about 4.0 V (vs. Li/Li+) and less than or equal to about 5.0 V, or greater than or equal to about 4.2 V and less than or equal to about 5.0 V. The shape of the rechargeable lithium-ion battery is not limited, it may be for example, cylindrical, prismatic, laminate-type (kind), button-type (kind), and/or the like.

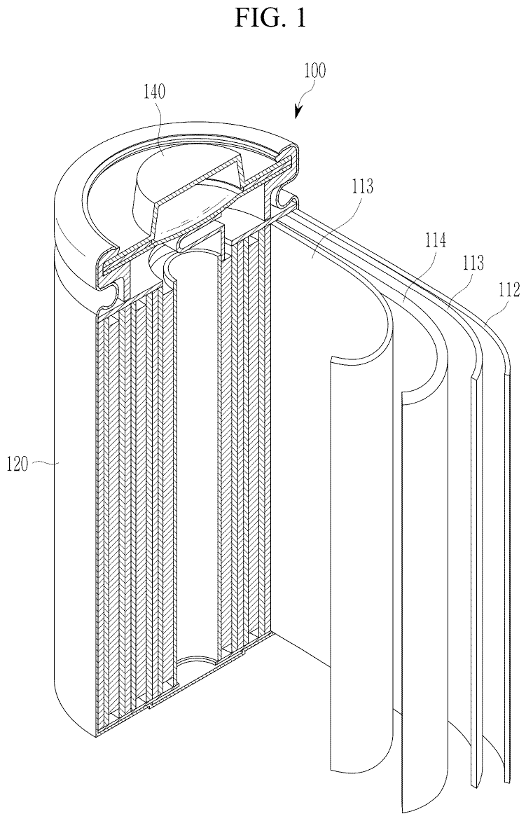

FIG. 1 is a schematic view illustrating a non-aqueous electrolyte rechargeable battery according to one or more embodiments.

Referring to FIG. 1, a rechargeable lithium battery 100 according to one or more embodiments includes a battery cell including a positive electrode 114, a negative electrode 112 opposite to (e.g., facing) the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

### 1-1. Positive Electrode

The positive electrode may include a positive electrode current collector and a positive electrode mixture layer formed on the positive electrode current collector.

The positive electrode current collector may be any conductor as long as it is a conductor, may be, for example, plate-shaped or thin-shaped, and suitably made of aluminum, stainless steel, nickel-coated steel, and/or the like (e.g., the positive electrode current collector may include aluminum, stainless steel, nickel-coated steel, and/or the like).

The positive electrode mixture layer includes a positive electrode active material, and may further include a conductive agent and a positive electrode binder.

The positive electrode active material may be, for example, a transition metal oxide containing lithium and/or solid solution oxide, and is not limited. For example, the positive electrode active material may be a material capable of electrochemically intercalating and deintercalating lithium ions.

Examples of the transition metal oxide containing lithium may include Li_{1.0}Ni_{0.88}Co_{0.1}Al_{0.01}Mg_{0.01}O₂, and/or the like. In addition, it may include Li—Co-based composite oxides such as LiCoO₂, and/or the like., Li—Ni—Co—Mn-based composite oxide such as LiNiₓCo_{y}Mn_{z}O₂, and/or the like., Li—Ni-based composite oxide, such as LiNiO₂, and/or the like., Li—Mn-based composite oxide, such as LiMn₂O₄, and/or the like. Examples of the solid solution oxide may include, LiₐMnₓCo_{y}Ni_{z}O₂ (1.150≤a≤1.430, 0.45≤x≤0.6, 0.10≤y≤0.15, 0.20≤z≤0.28), LiMn_{1.5}Ni_{0.5}O₄, and/or the like. In contrast, the content (e.g., amount) (e.g., a content ratio or an amount ratio) of the positive electrode active material is not limited, and any content (e.g., amount) applicable to the positive electrode mixture layer of the non-aqueous electrolyte rechargeable battery may be sufficient. Moreover, these compounds may be utilized independently, or plural types (kinds) may be mixed and utilized.

The conductive agent (e.g., electron conductor) is not particularly limited. For example, the conductive agent may be any material that increases the conductivity of the positive electrode.

One or more examples of the conductive agent include those including one or more selected from among carbon black, natural graphite, artificial graphite, and/or fibrous carbon.

Examples of the carbon black may include furnace black, channel black, thermal black, Ketjen black, and/or acetylene black.

Examples of the fibrous carbon may include a carbon nanotube, graphene, and/or a carbon nanofiber.

A content (e.g., amount) of the conductive agent is not limited, and may be any content (e.g., amount) applicable to the positive electrode mixture layer of a non-aqueous electrolyte rechargeable battery.

Examples of the positive electrode binder may include a fluorine-containing resin such as polyvinylidene fluoride, an ethylene-containing resin such as a styrene-butadiene rubber, an ethylene-propylene-diene terpolymer), an acrylonitrile-butadiene rubber, a fluororubber, polyvinyl acetate, polymethylmethacrylate, polyethylene, polyvinyl alcohol, carboxy methyl cellulose or carboxy methyl cellulose derivatives (such as a salt of carboxymethyl cellulose), and/or nitrocellulose.

The positive electrode binder may be any binder capable of binding the positive electrode current collector and the conductive agent on the positive current collector, and is not limited.

For example, the negative electrode binder described in more detail may be utilized as the positive electrode binder.

### 1-2. Negative Electrode

The negative electrode includes a negative electrode current collector and a negative electrode mixture layer formed on the negative electrode current collector.

The negative electrode current collector may be any conductor, for example, a plate-shaped or thin-shaped conductor, and may be desirably or suitably composed of (e.g., include) copper, stainless steel, nickel-plated steel, and/or the like.

The negative electrode mixture layer includes, for example, a negative electrode active material and a negative electrode binder.

The configuration of this negative electrode mixture layer is a characteristic feature of the present embodiment, and thus it will be described in more detail.

### 1-3. Separator

The separator is not limited, and any separator may be utilized as long as it is utilized as a separator of a rechargeable lithium-ion battery.

The separator may be a porous film or a nonwoven fabric having excellent or suitable high rate discharge performance that may be utilized alone or with other materials.

Examples of the resin constituting the separator (e.g., the separator includes the resin) may include a polyolefin-based resin such as polyethylene and polypropylene; a polyester-based resin such as polyethylene terephthalate and polybutylene terephthalate; polyvinylidene difluoride, a vinylidene difluoride-hexafluoropropylene copolymer, a vinylidene fluoride-perfluorovinylether copolymer, a vinylidene difluoride-tetrafluoroethylene copolymer, a vinylidene difluoride-trifluoroethylene copolymer, a vinylidene fluoride-fluoroethylene copolymer, a fluoride vinylidene-hexafluoroacetone copolymer, a vinylidene difluoride-ethylene copolymer, a vinylidene difluoride-propylene copolymer, a vinylidene fluoride-vinylidene difluoride-trifluoro propylene copolymer, a vinylidene fluoride-ethylene-tetrafluoroethylene copolymer, and/or a vinylidene difluoride-ethylene-tetrafluoroethylene copolymer.

In contrast, the porosity of the separator is not limited, and may be any porosity which a separator of any rechargeable lithium-ion battery has.

On the surface of the separator, there may be a heat-resistant layer including inorganic particles to improve heat resistance, or a layer including an adhesive to fix the battery element to the electrode.

Examples of the aforementioned inorganic particles include Al₂O₃, AlOOH, Mg(OH)₂, and/or SiO₂.

Examples of the adhesive may include a vinylidene fluoride-hexafluoropropylene copolymer, an acid-modified product of a vinylidene fluoride polymer, and/or a styrene-(meth)acrylic acid ester copolymer.

### 1-4. Non-Aqueous Electrolyte Solution

For the non-aqueous electrolyte solution, a non-aqueous electrolyte solution for a rechargeable lithium-ion battery may be utilized without a particular limitation. The non-aqueous electrolyte solution has a composition in which an electrolytic salt is contained in a non-aqueous solvent that is a solvent for an electrolyte solution.

The non-aqueous solvent may include, for example, cyclic carbonate esters such as propylene carbonate, ethylene carbonate, butylene carbonate, chloroethylene carbonate, fluoroethylene carbonate, and/or vinylene carbonate, cyclic esters such as γ-butyrolactone and/or γ-valerolactone, linear carbonates such as dimethyl carbonate, diethyl carbonate, and/or ethylmethyl carbonate, linear esters such as methyl formate, methyl acetate, methyl butyrate, ethyl propionate, and/or propyl propionate, ethers such as tetrahydrofuran or a derivative thereof, 1,3-dioxane, 1,4-dioxane, 1,2-dimethane 1,2-dimethoxyethane, 1,4-dibutoxyethane, methyldiglyme, ethylene glycol monopropyl ether, and/or propylene glycol monopropyl ether, and/or nitriles such as acetonitrile and benzonitrile, dioxolane or a derivative thereof, ethylene sulfide, sulfolane, and/or sultone or a derivative thereof, which may be utilized alone or in a mixture of two or more.

In contrast, if (e.g., when) two or more of the non-aqueous solvents are mixed and utilized, the mixing ratio of each non-aqueous solvent may be a mixing ratio that may be utilized in a rechargeable lithium-ion battery.

Examples of the electrolytic salt may include an inorganic ion salt including lithium (Li), sodium (Na), and/or potassium (K) such as LiClO₄, LiBF₄, LiAsF₆, LiPF₆, LiPF₆₋ₓ(CₙF₂ₙ₊₁)ₓ (provided that 1<x<6, n=1 or 2], LiSCN, LiBr, LiI, Li₂SO₄, Li₂B₁₀Cl₁₀, NaClO₄, NaI, NaSCN, NaBr, KClO₄, KSCN, an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phtalate, lithium stearyl sulfate, lithium octyl sulfate, and/or lithium dodecyl benzene sulfonate, and these ionic compounds may be utilized alone or in a mixture of two or more.

In contrast, the concentration of the electrolyte salt is the same as in the non-aqueous electrolyte solution utilized in the rechargeable lithium-ion battery, without a particular limitation. In one or more embodiments, the non-aqueous electrolyte solution may include the aforementioned lithium compound (e.g., electrolytic salt) at a concentration of greater than or equal to about 0.8 mol/L and less than or equal to about 1.5 mol/L.

In contrast, one or more suitable additives may be added to the non-aqueous electrolyte solution.

Examples of such additives may include an additive that acts on or for a negative electrode, an additive that acts on or for a positive electrode, an ester-based additive, a carbonate ester-based additive, a sulfuric acid ester-based additive, a phosphoric acid ester-based additive, a boric acid ester-based additive, an anhydride-based additive, and/or an electrolyte-based additive. To put it another way, examples of such additives may include those that enhance the performance of the negative electrode, those that enhance the performance of the positive electrode, ester-based additives, carbonate ester-based additives, sulfuric acid ester-based additives, phosphoric acid ester-based additives, boric acid ester-based additives, anhydride-based additives, and/or electrolyte-based additives.

One of these additives may be added to the non-aqueous electrolyte, or a plurality of types (kinds) of additives may be added to the non-aqueous electrolyte. For example, one or more of these additives may be added to the non-aqueous electrolyte.

### 2. Manufacturing Method of Non-Aqueous Electrolyte Rechargeable Battery According to the Present Embodiment

Next, the method for manufacturing a rechargeable lithium-ion battery is explained.

The positive electrode is manufactured as follows.

First, a positive electrode slurry is formed by dispersing a mixture of a positive electrode active material, a conductive agent, and a positive electrode binder in a desired or suitable ratio in a solvent (e.g., N-methyl-2-pyrrolidone) for positive electrode slurry.

Next, the positive electrode slurry is applied onto the positive electrode current collector and dried to form a positive electrode mixture layer.

In addition, the coating method is not limited. The coating method may be, for example, a knife coater method, a gravure coater method, a reverse roll coater method, and/or a slit die coater method. Each of the coating method may be also performed by the same method. Next, the positive electrode mixture layer may be pressed to a desired or suitable density by a press machine. Thereby, a positive electrode is manufactured.

The negative electrode may be also manufactured in substantially the same way as the positive electrode.

First, a negative electrode slurry is prepared by dispersing a mixture of materials constituting the negative electrode mixture layer in a solvent (e.g., an aqueous solvent such as water) for negative electrode slurry.

Then, the negative electrode slurry is coated onto the negative current collector and dried to form a negative electrode mixture layer.

Subsequently, the negative electrode mixture layer is pressed to a desired or suitable density with a press machine.

Accordingly, a negative electrode is manufactured.

Subsequently, an electrode structure is produced by sandwiching a separator between the positive electrode and the negative electrode.

Then, the electrode structure is processed into a desired or suitable shape (e.g., a cylindrical shape, a prismatic shape, a laminated shape, a buttoned shape, and/or the like), and inserted into a container of the above shape.

Then, by injecting the non-aqueous electrolyte solution into the container, the electrolyte is impregnated into the pores in the separator and the voids of the positive electrode and the negative electrode.

By the above process, a rechargeable lithium-ion battery may be manufactured.

### 3. Characteristic Features of Non-Aqueous Electrolyte Rechargeable Battery

Hereinafter, the negative electrode mixture layer, which is a characteristic feature of a non-aqueous electrolyte rechargeable battery according to one or more embodiments, the negative electrode slurry, a binder composition, and a binder utilized to form the negative electrode mixture layer are described in more detail.

### 3-1. Negative Electrode Mixture Layer

The negative electrode mixture layer is formed by coating the negative electrode slurry to one or both surfaces (e.g., opposite surfaces) of the negative electrode current collector simultaneously, drying, and pressing, as described above.

In the drying process, the solvent for the negative electrode slurry evaporates, and the solid components such as the negative electrode active material and/or the negative electrode binder dispersed in the negative electrode slurry remain on the negative electrode current collector to form the negative electrode mixture layer. Therefore, a content (e.g., amount) ratio of each component in the negative electrode mixture layer directly reflects a content (e.g., amount) ratio of the solid components in the negative electrode slurry.

The negative electrode mixture layer has an area capacity after pressing in the range of greater than or equal to 3.5 mAh/cm₂ and less than or equal to about 10 mAh/cm₂.

In forming such a negative electrode mixture layer, the aforementioned negative electrode slurry may be coated at a coating amount of, for example, greater than or equal to 5 mg/cm₂ and less than or equal to about 25 mg/cm₂, and for example, at a coating amount of greater than or equal to about 10 mg/cm₂ and less than or equal to about 20 mg/cm₂ as a surface density on one surface of the negative electrode current collector.

In addition, the thickness of the negative electrode mixture layer after drying and pressing may be, for example, greater than or equal to about 50 μm and less than or equal to about 150 μm as the thickness of one surface of the negative electrode current collector.

By setting the coating amount and thickness of the negative electrode mixture layer within this range (e.g., a range from about 50 μm to about 150 μm), the charge/discharge capacity of the rechargeable lithium-ion battery may be increased.

In one or more embodiments, the negative electrode mixture layer may additionally include a conductive agent.

The conductive agent may be, for example, one of the conductive agents exemplified by those utilized at the positive electrode.

### 3-2. Negative Electrode Slurry

The negative electrode slurry includes, for example, a negative electrode active material and a negative electrode binder.

The negative electrode slurry may also include a solvent for a negative electrode slurry that disperses or dissolves the negative electrode active material and the negative electrode binder.

The negative electrode active material includes, for example, a graphite-based active material including graphite.

Examples of the graphite-based active material may include, for example, at least one active material selected from among cokes such as coal-based coke, petroleum-based pure coke, calcined coke, and/or needle coke, artificial graphite obtained by graphitizing graphite precursors such as mesophase carbons such as mesophase spherules and/or bulk mesophase at about 1500° C. or higher, or for example about 2800° C. to about 3200° C., natural graphite in the form of scales, lumps and/or granulated spheroids, a mixture of artificial graphite and natural graphite, natural graphite coated with artificial graphite, and/or the like. These may be subjected to chemical or physical treatment, and treatment methods may include pulverization, classification, granulation, lamination, compression, compounding, mixing, coating, oxidation, vapor deposition, mechanochemical treatment, angle-removal, spheroidization, curvature, heat treatment, and/or the like. In the case of artificial graphite, either before or after the graphitization treatment may be possible, these treatments may be combined. Examples of the artificial graphite may include, but are not limited to, mesocarbon microbeads (MCMB), mesocarbon fibers (MCF), and/or massive artificial graphite (MAG).

The negative electrode active material may further include, in addition to the

above, for example, at least one negative electrode active material selected from among a Si-based active material including silicon, a Sn-based active material (e.g., a mixture of tin (Sn) or tin oxide particles and a graphite-based active material, tin particles, and/or an alloy based on tin), metal lithium and/or titanium oxide compounds such as Li₄Ti₅O₁₂, lithium nitride, and/or the like.

If (e.g., when) the solid content (e.g., amount) of the negative electrode slurry is greater than or equal to about 40 wt % and less than or equal to about 60 wt %, the viscosity of the negative electrode slurry as measured by a B-type (kind) viscometer may be greater than or equal to about 1000 mPa·s and less than or equal to about 8000 mPa·s, for example greater than or equal to about 1500 mPa·s and less than or equal to about 7000 mPa·s at 25° C.

The viscosity of this negative electrode slurry may be controlled or selected, for example, by the amount of the water-soluble polymer compound added.

In one or more embodiments, it is desirable that this viscosity be maintained within the aforementioned range (e.g., a range from about 1000 mPa·s to about 8000 mPa·s) with little change over time after the negative electrode slurry is prepared.

### 3-3. Binder for Non-Aqueous Electrolyte Rechargeable Battery

The negative electrode mixture layer and the negative electrode slurry of the rechargeable battery according to one or more embodiments include the negative electrode binder for binding the negative electrode active materials together for coating the negative electrode mixture layer on (e.g., onto) the negative electrode current collector, and the negative electrode binder may be a water-soluble polymer compound binder made of (e.g., including) a particulate binder having a core-shell structure including a hydrophobic core and a hydrophilic shell around (e.g., surrounding) the hydrophobic core (which may be also referred as the binder for the non-aqueous electrolyte rechargeable battery according to one or more embodiments, or a first binder), and a water-soluble polymer compound (which may be also referred as a second binder).

The water-soluble polymer compound is not limited, for example, the water-soluble polymer compound may be a compound that imparts good or suitable viscosity to the negative electrode slurry and may suppress or reduce sedimentation of the negative electrode active material, even after time has elapsed after the preparation of the negative electrode slurry, and may be, for example, an alkali metal salt of carboxymethyl cellulose.

A content (e.g., amount) of the water-soluble polymer compound binder in the negative electrode slurry may be greater than or equal to about 0.5 wt % and less than or equal to about 2.0 wt %, if (e.g., when) a total amount of the negative electrode active material, the binder for the non-aqueous electrolyte rechargeable battery, and the water-soluble polymer compound binder is 100 wt %.

If (e.g., when) the content (e.g., amount) of the water-soluble polymer compound binder is greater than or equal to about 0.5 wt %, it may provide good or suitable viscosity to the negative electrode slurry for coating the negative electrode mixture layer and suppress or reduce sedimentation of the negative electrode active material during storage of the negative electrode slurry.

In addition, if the content (e.g., amount) of the water-soluble polymer compound binder is less than or equal to about 2.0 wt %, the slurry for coating the negative electrode mixture layer will not be excessively (or substantially) viscous, and thus the slurry may be coated in a high solids state and may be efficiently dried to obtain a negative electrode.

The content (e.g., amount) of the binder for the non-aqueous electrolyte rechargeable battery in the negative electrode slurry may be greater than or equal to about 1.0 wt % and less than or equal to about 3.0 wt % if (e.g., when) the total amount of the negative electrode active material, the binder for the non-aqueous electrolyte rechargeable battery, and the water-soluble polymer compound binder is 100 wt %.

If (e.g., when) the content (e.g., amount) of the binder for the non-aqueous electrolyte rechargeable battery is greater than or equal to about 1.0 wt %, it may suppress or reduce cracking or peeling of the negative electrode mixture layer if (e.g., when) the negative electrode mixture layer is coated, dried, and rolled (pressed).

In addition, if (e.g., when) the content (e.g., amount) of the binder for the non-aqueous electrolyte rechargeable battery is less than or equal to about 3.0 wt %, it suppresses excessive increase in electrode resistance, and a negative electrode with good or suitable cycle performance may be obtained.

The binder for the non-aqueous electrolyte rechargeable battery may be water-dispersible particulates that may be uniformly (e.g., substantially uniformly) dispersed in an aqueous solvent such as water, which is a solvent for the negative electrode slurry, due to its surface being formed by the hydrophilic shell. For example, because the surface of the particulate binder in the negative electrode binder may include the hydrophilic shell, the negative electrode binder is able to be evenly dispersed in an aqueous solvent.

The aqueous solvent may be, in addition to the aforementioned water, a mixture of water, and an organic solvent miscible with water, for example, an organic solvent having a water content (e.g., amount) of greater than or equal to about 50 wt % based on 100 wt % of the organic solvent.

Examples of the organic solvent that is miscible with water include a water-soluble alcohol.

An average particle size of the binder for the non-aqueous electrolyte rechargeable battery measured by a wet laser diffraction scattering method may be greater than or equal to about 250 nm and less than or equal to about 1000 nm, for example greater than or equal to about 300 nm and less than or equal to about 750 nm. If (e.g., when) the average particle size of the binder for the non-aqueous electrolyte rechargeable battery is greater than or equal to about 250 nm, it may improve an adhesion between the electrode mixture layer and the current collector (e.g., improve a peeling strength of the electrode) and also reduce the internal resistance of the battery. In addition, if (e.g., when) the average particle size of the binder for the non-aqueous electrolyte rechargeable battery is less than or equal to about 1000 nm, it may further suppress or reduce the occurrence of cracks in the electrode during coating and drying process of the negative electrode slurry.

The hydrophobic core is formed by a hydrophobic polymer. The hydrophobic core may be spherical. The hydrophobic polymer may a polymer including at least one selected from among, for example, a derivative from (e.g., a unit derived from) an aromatic vinyl monomer, a derivative from an unsaturated carboxylic acid alkyl ester monomer, a derivative from a (meth)acrylic acid monomer, and/or a derivative from an unsaturated carboxylic acid amide monomer.

The hydrophobic polymer may include a derivative from an aromatic vinyl monomer, a derivative from an unsaturated carboxylic acid alkyl ester monomer, a derivative from a (meth)acrylic acid monomer, and/or a derivative from an unsaturated carboxylic acid amide monomer.

Examples of the aromatic vinyl monomer may include styrene, p-methylstyrene, m-methylstyrene, p-t-butyl styrene, m-t-butyl styrene, and/or the like. Among these, styrene may be suitable.

Examples of the unsaturated carboxylic acid alkyl ester monomer may include 2-ethylhexyl (meth)acrylate, n-octyl (meth)acrylate, octyl (meth)acrylate, butyl (meth)acrylate, ethyl (meth)acrylate, methyl (meth)acrylate, cyclohexyl (meth)acrylate, isobornyl (meth)acrylate, and/or the like.

Among these, 2-ethylhexyl (meth)acrylate may be suitable.

Examples of the (meth)acrylic acid monomer may include (meth)acrylic acid, itaconic acid, maleic acid, fumaric acid, and/or the like.

Examples of the unsaturated carboxylic acid amide monomer may include (meth)acrylamide, (meth)N-methyl acrylamide, (meth)N-t-butyl acrylamide, (meth)N-hydroxymethyl acrylamide, (meth)N-butoxymethyl acrylamide, and/or the like. Other copolymerizable monomers may include 2-hydroxyethyl (meth)acrylate, 2-hydroxypropyl (meth)acrylate, 4-hydroxybutyl (meth)acrylate, 2-hydroxy-3-phenoxypropyl (meth)acrylate, glycidyl (meth)acrylate, methoxyethyl (meth)acrylate, 1,4-butanediol diacrylate, 1,4-butanediol dimethacrylate, and/or divinyl benzene.

The hydrophilic shell may be formed to cover the surface of the hydrophobic core, thereby enabling the hydrophobic core to be dispersed in an aqueous solvent, and may be made of (e.g., include) a water-soluble polymer. The water-soluble polymer may include at least one selected from among, for example, the derivative from the (meth)acrylic acid monomer, the derivative from the sodium styrene sulfonate monomer, and the derivative from the (meth)acrylonitrile monomer.

The water-soluble polymer may include an acrylic acid-sodium styrene sulfonate-acrylonitrile terpolymer (also referred to as an AA-NaSS-AN copolymer).

The AA-NaSS-AN copolymer may include a derivative from an (meth)acrylic acid monomer, a derivative from a sodium styrene sulfonate monomer, and a derivative from a (meth)acrylonitrile monomer.

The water-soluble polymer (e.g., AA-NaSS-AN copolymer) may include, for example, greater than or equal to about 10 wt % and less than or equal to about 50 wt % of the derivative from the (meth)acrylic acid monomer, greater than or equal to about 10 wt % and less than or equal to about 50 wt % of the derivative from the sodium styrene sulfonate monomer, and greater than or equal to about 10 wt % and less than or equal to about 50 wt % of the derivative from the (meth)acrylonitrile monomer, based on 100 wt % of the water-soluble polymer (e.g., AA-NaSS-AN copolymer).

The water-soluble polymer (e.g., AA-NaSS-AN copolymer) may include a derivative from other monomers that may be copolymerized with the (meth)acrylic acid monomer, the sodium styrene sulfonate monomer, and/or the (meth)acrylonitrile monomer, and the content (e.g., amount) of the derivative from other monomers may be in a range of greater than about 0 wt % and less than or equal to about 20 wt % based on 100 wt % of the water-soluble polymer (e.g., AA-NaSS-AN copolymer).

If (e.g., when) a content (e.g., amount) of the derivative from the (meth)acrylic acid monomer in the AA-NaSS-AN copolymer is greater than or equal to about 10 wt %, the acrylic acid-sodium styrene sulfonate-acrylonitrile copolymer (e.g., the AA-NaSS-AN copolymer) becomes soluble (e.g., substantially or suitably soluble) in water, which improves the dispersibility of the negative electrode active material and the preservation stability of the negative electrode slurry.

In addition, if (e.g., when) the content (e.g., amount) of the derivative from the (meth)acrylic acid monomer in the AA-NaSS-AN copolymer is less than or equal to about 50 wt %, the occurrence of cracks in the application and drying process of the negative electrode slurry may be further suppressed or reduced.

If (e.g., when) a content (e.g., amount) of the derivative from the sodium styrene sulfonate monomer in the AA-NaSS-AN copolymer is greater than or equal to about 10 wt %, the swelling property of the water-soluble copolymer (e.g., the AA-NaSS-AN copolymer) into the electrolyte solution may be further suppressed or reduced, and the high-temperature cycle performance may be further improved.

In addition, if the content (e.g., amount) of the derivative from sodium styrene sulfonate monomer in the AA-NaSS-AN copolymer may be less than or equal to about 50 wt %, the occurrence of cracks during the coating and drying process of the negative electrode slurry may be further suppressed or reduced.

If a content (e.g., amount) of the derivative from the (meth)acrylonitrile monomer in the AA-NaSS-AN copolymer is greater than or equal to about 10 wt %, the adhesion of the negative electrode mixture layer to the negative electrode current collector may be further improved.

In addition, if the content (e.g., amount) of the derivative from the (meth)acrylonitrile monomer in the AA-NaSS-AN copolymer is 50 wt % or less, the AA-NaSS-AN copolymer becomes soluble in water, and thus the AA-NaSS-AN copolymer improves or enhances the dispersibility of the negative electrode active material and the storage stability of the negative electrode slurry.

If (e.g., when) the content (e.g., amount) of a derivative from other monomers copolymerizable with the (meth)acrylic acid monomer, sodium styrene sulfonate monomer, and/or (meth)acrylonitrile monomer, which are raw materials for the AA-NaSS-AN copolymer, is less than or equal to about 20 wt % based on 100 wt % of the AA-NaSS-AN copolymer, it may suppress or reduce the occurrence of cracks in the process of applying and drying the negative electrode slurry and the peeling of the negative electrode mixture layer from the negative electrode current collector during charging.

The (meth)acrylic acid monomer may include at least one selected from among (meth)acrylic acid, a metal salt of (meth)acrylic acid, an ammonium salt of (meth)acrylic acid, and/or an amine salt of (meth)acrylic acid.

The metal salt of the (meth)acrylic acid may be, for example, an alkali metal salt of (meth)acrylic acid.

Examples of the metal salt of (meth)acrylic acid may include sodium acrylate, lithium acrylate, potassium acrylate, calcium acrylate, magnesium acrylate, sodium methacrylate, lithium methacrylate, potassium methacrylate, calcium methacrylate, and/or the like.

Among these, sodium acrylate may be suitable.

The ammonium salt of the (meth)acrylic acid may include ammonia-neutralized (meth)acrylic acid, monoethanolamine-neutralized (meth)acrylic acid, diethanolamine-neutralized (meth)acrylic acid, and/or hydroxylamine-neutralized (meth)acrylic acid.

Among these, the ammonia-neutralized acrylic acid may be suitable.

In the AA-NaSS-AN copolymer, other monomers copolymerizable with the (meth)acrylic acid monomer, sodium styrene sulfonate monomer, and/or (meth)acrylonitrile monomer may be, for example, a water-soluble monomer. Examples of the water-soluble monomers may include (meth)acrylamide, 2-acrylamide-2-methylpropanesulfonic acid, N-isopropyl acrylamide, N-(2-hydroxyethyl)acrylamide, N-(2-hydroxyethyl)methacrylamide, 2-hydroxyethyl (meth)acrylic acid, vinyl pyrrolidone, vinylacetamide, vinylformamide, vinyl alcohol, and/or the like.

An average molecular weight of the AA-NaSS-AN copolymer may be greater than or equal to about 300,000 and less than or equal to about 2,000,000, for example less than or equal to about 1,600,000, or less than or equal to about 1,500,000. This weight average molecular weight may be measured by gel permeation chromatography (GPC) as described in Examples.

If (e.g., when) the average molecular weight of the AA-NaSS-AN copolymer is within the aforementioned range (e.g., a range of greater than or equal to about 300,000 and less than or equal to about 2,000,000, 1,600,000, or 1,500,000), it is suitable not to add a derivative from a crosslinkable monomer as a derivative from the other monomers. By not adding the derivative from the crosslinkable monomer, the water solubility of the water-soluble copolymer may be suppressed or reduced from decreasing, and the dispersibility of the negative electrode active material may be prevented or reduced from being damaged, resulting in a decrease in cycle performance. In one or more embodiments, the crosslinkable monomer may be broadly referred as a compound having at least two ethylenically unsaturated bonds, and examples may include methylene bisacrylamide, ethylene glycol di (meth)acrylate, trimethylolpropane tri(meth)acrylate, and/or divinylbenzene.

A viscosity of the aqueous solution of 9.5 wt % of the AA-NaSS-AN copolymer as measured by a B-type (kind) viscometer at 25° C. may be in the range of greater than or equal to about 500 mPa·s and less than or equal to about 20,000 mPa·s. If (e.g., when) the viscosity of the aqueous solution of the AA-NaSS-AN copolymer is greater than or equal to about 500 mPa·s, the adhesion of the negative electrode mixture layer to the negative electrode current collector may be improved, and good or suitable cycle performance may be obtained. In addition, if the viscosity of the AA-NaSS-AN copolymer aqueous solution is less than or equal to about 20,000 mPa·s, the negative electrode slurry for forming the negative electrode mixture layer is not suitable to be excessively (or substantially) viscous, and thus the slurry may be coated in a high solids state, and the negative electrode slurry may be efficiently dried to obtain a negative electrode. In one or more embodiments, the solid content (e.g., amount) may be referred as a remainder if (e.g., when) the solvent is removed in the form of a slurry, aqueous solution, and/or aqueous dispersion.

The solid content (e.g., amount) in the negative electrode slurry is considered to be equal to the weight of the negative electrode mixture layer in a dry state.

Based on 100 wt % of the binder for the non-aqueous electrolyte rechargeable battery, the content (e.g., amount) of the hydrophobic core may be greater than or equal to about 90 wt % and less than or equal to about 97 wt %, and the content (e.g., amount) of the hydrophilic shell may be greater than or equal to about 3 wt % and less than or equal to about 10 wt %.

If (e.g., when) the content (e.g., amount) of the hydrophobic core in the binder for the non-aqueous electrolyte rechargeable battery is less than or equal to about 97 wt %, and the content (e.g., amount) of the hydrophilic shell is greater than or equal to about 3 wt %, peeling of the negative electrode mixture layer from the negative electrode current collector during charge and discharge may be suppressed or reduced.

In addition, if (e.g., when) the content (e.g., amount) of the hydrophobic core in the binder for the non-aqueous electrolyte rechargeable battery is greater than or equal to about 90 wt % and the content (e.g., amount) of the hydrophilic shell is less than or equal to about 10 wt %, the adhesion between the negative electrode mixture layer and the negative electrode current collector (the peeling strength of the electrode) is excellent or suitable, and the internal resistance of the battery may be reduced.

### 4. Method for Manufacturing Binder for Non-aqueous Electrolyte Rechargeable Battery According to the Present Embodiment

The negative electrode binder (e.g., the binder for a non-aqueous electrolyte

rechargeable battery) according to one or more embodiments may be manufactured, for example, by the following process.

### 4-1. Synthesis of Water-Soluble Copolymer (Water-Soluble Polymer)

In a flask, an (meth)acrylic acid monomer, a sodium styrene sulfonate monomer, a (meth)acrylonitrile monomer, and other polymerizable monomers are mixed, and stirred so that they are suitably separated in an aqueous solution including sodium hydroxide and/or ammonia.

Then, the inside of the flask was substituted with nitrogen and heated to 60° C.

If (e.g., when) the temperature of the solution reaches 60° C., a reaction initiator is added and polymerization is initiated.

An aqueous solution of a water-soluble copolymer may be obtained by reacting while stirring.

### 4-2. Synthesis of Binder for Non-Aqueous Electrolyte Rechargeable Battery

Into a flask, an aqueous solution of a water-soluble polymer obtained as described above and a monomer that is a raw material for the hydrophobic polymer described above are placed, and then the inside of the flask is replaced with nitrogen and heated to 60° C. At the point where the temperature of the solution reaches 60° C., a reaction initiator is added and polymerization is initiated.

By conducting a polymerization reaction while stirring in the presence of a water-soluble copolymer, a hydrophobic polymer is synthesized in a stably dispersed state in water, and an aqueous dispersion of a binder for a non-aqueous electrolyte rechargeable battery is obtained.

In one or more embodiments, during the polymerization reaction to form a hydrophobic polymer, a portion of the water-soluble polymer may form a chemical bond, such as an ionic bond, hydrogen bond, or covalent bond, with the hydrophobic polymer, or the hydrophobic polymer and the water-soluble polymer may be fixed to each other by other methods, such as an anchoring effect caused by entanglement of the hydrophobic polymer and the water-soluble polymer.

Reaction initiators for the water-soluble polymer and hydrophobic polymer, may be for example, an azo compound such as α, α′-azobisisobutyronitrile, 2,2′-azobis(2-methyl-N-2-hydroxyethylpropionamide), and/or 2,2′-azobis[N-(2-carboxyethyl)-2-methylpropionamidine]tetrahydrate, a persulfate such as ammonium persulfate and/or potassium persulfate, and/or the like.

The synthesized binder for a non-aqueous electrolyte rechargeable battery may be obtained by drying the solvent, such as water, by removing the solvent, but it may also be utilized as a binder composition for a non-aqueous electrolyte rechargeable battery in the form of an aqueous dispersion. If (e.g., when) the aqueous dispersion is utilized as a binder composition for a non-aqueous electrolyte rechargeable battery, the trouble of removing the solvent or re-expanding the binder for the non-aqueous electrolyte rechargeable battery with a solvent may be reduced if (e.g., when) utilized, and the synthesized binder for a non-aqueous electrolyte rechargeable battery may be utilized with its original properties in a negative electrode slurry, and/or the like.

In one or more embodiments, as a solvent for the binder composition for a non-aqueous electrolyte rechargeable battery, the same solvent as that utilized in the negative electrode slurry described above may be utilized.

### 5. Effects of the Present Embodiment

According to the binder for the non-aqueous electrolyte rechargeable battery, the binder composition for the non-aqueous electrolyte rechargeable battery, the negative electrode slurry, the negative electrode mixture layer formed by the negative electrode slurry, and the negative electrode configured as described above, the following effects may be achieved.

The binder for the non-aqueous electrolyte rechargeable battery is a particle-shaped binder having a core-shell structure including a hydrophobic core and a hydrophilic shell.

The hydrophobic core includes at least one selected from among a derivative from an aromatic vinyl monomer, a derivative from an unsaturated carboxylic acid alkyl ester monomer, a derivative from a (meth)acrylic acid monomer, and/or a derivative from an unsaturated carboxylic acid amide monomer.

The hydrophilic shell includes a derivative from a (meth)acrylic acid monomer, a derivative from a sodium styrene sulfonate monomer, and/or a derivative from a (meth)acrylonitrile monomer.

A content (e.g., amount) of the hydrophobic core is greater than or equal to about 90 wt % and less than or equal to about 97 wt %, and a content (e.g., amount) of the hydrophilic shell is greater than or equal to about 3 wt % and less than or equal to about 10 wt % based on 100 wt % of the binder for the non-aqueous electrolyte rechargeable battery.

An average particle size of the binder for the non-aqueous electrolyte rechargeable battery measured by a wet laser diffraction scattering method is greater than or equal to about 250 nm and less than or equal to about 1000 nm, thereby improving adhesion between the negative electrode mixture layer and the negative electrode current collector, and also reducing the internal resistance of the battery compared to prior arts.

### EXAMPLES

Hereinafter, the present disclosure will be described in more detail with one or more examples. However, the following examples are merely examples of the present disclosure, and the present disclosure is not limited to the following examples.

In the present Example, first, Binders A to H for non-aqueous electrolyte rechargeable batteries described in Table 1 were synthesized.

Then, negative electrode slurries including these Binders A to H for non-aqueous electrolyte rechargeable batteries were prepared, and rechargeable battery cells of Examples 1 to 4 and Comparative Examples 1 to 5 were manufactured, and these rechargeable battery cells were evaluated.

Hereinafter, each example and comparative example is described.

### Synthesis of Water-Soluble Polymer

39.0 g of acrylic acid, 39.0 g of sodium p-styrene sulfonate, 42.0 g of acrylonitrile, 202.9 g of ion exchanged water, and 1975 mg of 2,2′-azobis(2-methyl-N-2-hydroxyethylpropionamide) were injected into a flask and then, polymerized at a polymerization temperature of 85° C. for more than 4 hours. Thereafter, the reaction solution was concentrated by heating and depressurizing distillation to remove unreacted monomers, and then ammonia water and ion-exchange water were added thereto to adjust a concentration of the solid content (e.g., amount) and a pH value of the polymer aqueous solution, thereby obtaining a water-soluble polymer aqueous solution having a solid content (e.g., amount) of 9.5 wt % and a pH value of 7.5. The weight average molecular weight of the obtained water-soluble polymer was 900,000, and the polydispersity was 3.1. In addition, a 9.5 wt % polymer aqueous solution of the obtained water-soluble polymer had viscosity of 9200 mPa·s at 25° C. and 30 rpm in a B-type (kind) viscometer. In contrast, because the unreacted monomers were almost not removed, the contents (e.g., amounts) of the used raw materials were utilized as a content (e.g., amount) ratio of a derivative from each monomer in the water-soluble polymer. In the present Example, the water-soluble polymer with a molecular weight of less than 900,000 was utilized, but it goes without saying that the water-soluble polymer may have a molecular weight other than this. If (e.g., when) the water-soluble polymer has a molecular weight of greater than or equal to 300,000, it is suitable because the negative electrode mixture layer including the binder for a non-aqueous electrolyte rechargeable battery manufactured utilizing the water-soluble polymer is difficult to be peeled off from the negative electrode current collector. In addition, if (e.g., when) the water-soluble polymer has molecular weight of less than or equal to 2,000,000, the water-soluble polymer may not only be prepared in a suitable method without a special process, but also an aqueous solution of the water-soluble polymer may be prevented or reduced from having an excessively (or substantially) low concentration.

### Synthesis of Binder A for Non-Aqueous Electrolyte Rechargeable Battery

57.89 g of the water-soluble polymer aqueous solution having a concentration of the solid content (e.g., amount) of 9.5 wt % and a pH value of 7.5 was injected with 52.25 g of 2-ethylhexyl acrylate, 51.89 g of styrene, and 0.36 g of 1,4-butanediol diacrylate as raw materials for a hydrophobic polymer and 396.5 g of ion exchanged water into a flask, and after increasing a temperature inside the system to 65° C., an initiator solution prepared by dissolving 942 mg of 2,2′-azobis[N-(2-carboxylethyl)-2-methylpropionamidine] tetrahydrate in 10.0 g of ion exchanged water was added thereto. Polymerization was performed at the polymerization temperature of 65° C. for more than 12 hours, and a milky white dispersion was obtained. This milky white dispersion was a liquid including Binder A for a non-aqueous electrolyte rechargeable battery.

This liquid was in a state that Binder A for a non-aqueous electrolyte rechargeable battery, in which a hydrophobic core formed by a hydrophobic polymer produced by copolymerization of 2-ethylhexyl acrylate, styrene, and 1,4-butanediol diacrylate as the raw materials for a hydrophobic copolymer was covered with a hydrophilic shell formed of the water-soluble polymer, was stably dispersed.

The aqueous dispersion had a nonvolatile component of 19.3 wt %, which was measured after the reaction.

Thereafter, the reaction solution was concentrated by heating and depressurizing distillation to remove unreacted monomers, and then ammonia water and ion-exchange water were added thereto to adjust the concentration of the solid content (e.g., amount) and the pH value, thereby obtaining an aqueous dispersion of Binder A for a non-aqueous electrolyte rechargeable battery having a solid content (e.g., amount) of 20 wt % and a pH value of 7.5 (Binder Composition A for a non-aqueous electrolyte rechargeable battery).

The obtained Binder Composition A for a non-aqueous electrolyte rechargeable battery, the aqueous dispersion having a solid content (e.g., amount) of 20 wt %, had viscosity of 300 mPa·s at 25° C. and 30 rpm in a B-type (kind) viscometer.

Even in this step (e.g., act or task), because the unreacted monomers were almost not removed, the contents of the raw materials utilized above were as a content (e.g., amount) ratio of a derivative from each monomer in the hydrophobic polymer or the binder for a non-aqueous electrolyte rechargeable battery.

This relationship of the contents of the raw materials and the content (e.g., amount) of each component in the hydrophobic polymer or the binder for a non-aqueous electrolyte rechargeable battery may be equally applied to the binder for a non-aqueous electrolyte rechargeable battery other than those described herein.

In addition, even if (e.g., when) the binder for a non-aqueous electrolyte rechargeable battery prepared as described above was centrifuged at 10,000 rpm for 5 minutes, no separation of the hydrophobic copolymer forming the hydrophobic core and the hydrophilic copolymer (i.e., the hydrophobic polymer) forming the hydrophilic shell confirmed that the hydrophobic core and the hydrophilic shell were chemically bonded to each other.

### Synthesis of Binder B for Non-Aqueous Electrolyte Rechargeable Battery

57.89 g of the water-soluble polymer aqueous solution having a concentration of the solid content (e.g., amount) of 9.5 wt % and a pH value of 7.5 was injected with 52.25 g of 2-ethylhexyl acrylate, 51.89 g of styrene, and 0.36 g of 1,4-butanediol diacrylate as raw materials for a hydrophobic polymer and 396.5 g of ion exchanged water into a flask, and after increasing a temperature inside the system to 65° C., an initiator solution prepared by dissolving 850 mg of 4,4′-azobis (4-cyanovaleric acid) in 20.0 g of ion exchanged water was added thereto. Polymerization was performed at the polymerization temperature of 65° C. for more than 12 hours, and a milky white dispersion was obtained. This milky white dispersion was a liquid including Binder B for a non-aqueous electrolyte rechargeable battery.

This liquid was in a state that Binder B for a non-aqueous electrolyte rechargeable battery, in which a hydrophobic core formed of a hydrophobic polymer produced by copolymerization of 2-ethylhexyl acrylate, styrene, and 1,4-butanediol diacrylate added as the raw materials for a hydrophobic polymer was covered with a hydrophilic shell formed of the water-soluble polymer, was stably dispersed in water.

The aqueous dispersion had a nonvolatile component of 19.2 wt %, which was measured after the reaction.

Thereafter, the reaction solution was concentrated by heating and depressurizing distillation to remove unreacted monomers, and then ammonia water and ion-exchange water were added thereto to adjust the concentration of the solid content (e.g., amount) and the pH value, thereby obtaining an aqueous dispersion of Binder B for a non-aqueous electrolyte rechargeable battery having a solid content (e.g., amount) of 20 wt % and the pH value of 7.5 (Binder Composition B for a non-aqueous electrolyte rechargeable battery).

The obtained Binder Composition B for a non-aqueous electrolyte rechargeable battery, the aqueous dispersion having a solid content (e.g., amount) of 20 wt %, had viscosity of 370 mPa·s at 25° C. and 30 rpm in a B-type (kind) viscometer.

### Synthesis of Binder C for Non-Aqueous Electrolyte Rechargeable Battery

89.19 g of the water-soluble polymer aqueous solution having a concentration of the solid content (e.g., amount) of 9.5 wt % and a pH value of 7.5 was injected with 52.25 g of 2-ethylhexyl acrylate, 51.89 g of styrene, and 0.36 g of 1,4-butanediol diacrylate as raw materials for a hydrophobic polymer and 385.3 g of ion exchanged water into a flask, and after increasing a temperature inside the system to 65° C., an initiator solution prepared by dissolving 942 mg of 2,2′-azobis[N-(2-carboxylethyl)-2-methylpropionamidine] tetrahydrate in 10.0 g of ion exchanged water was added thereto. Polymerization was performed at the polymerization temperature of 65° C. for more than 12 hours, and a milky white dispersion was obtained.

This milky white dispersion was a liquid including Binder C for a non-aqueous electrolyte rechargeable battery.

This liquid was in a state that Binder C for a non-aqueous electrolyte rechargeable battery, in which a hydrophobic core formed of a hydrophobic polymer produced by copolymerization of 2-ethylhexyl acrylate, styrene, and 1,4-butanediol diacrylate added as the raw materials for a hydrophobic copolymer was covered with a hydrophilic shell formed of the water-soluble polymer, was stably dispersed in water.

The aqueous dispersion had a nonvolatile component of 19.4 wt %, which was measured after the reaction.

Thereafter, the reaction solution was concentrated by heating and depressurizing distillation to remove unreacted monomers, and then ammonia water and ion-exchange water were added to adjust the concentration of the solid content (e.g., amount) and the pH value, thereby obtaining an aqueous dispersion of Binder C for a non-aqueous electrolyte rechargeable battery having a solid content (e.g., amount) of 20 wt % and a pH value of 7.5 (Binder Composition C for a non-aqueous electrolyte rechargeable battery).

The obtained Binder Composition C for a non-aqueous electrolyte rechargeable battery, the aqueous dispersion having a solid content (e.g., amount) of 20 wt %, had viscosity of 480 mPa·s at 25° C. and 30 rpm in a B-type (kind) viscometer.

### Synthesis of Binder D for Non-Aqueous Electrolyte Rechargeable Battery

99.42 g of the water-soluble polymer aqueous solution having a concentration of the solid content (e.g., amount) of 9.5 wt % and a pH value of 7.5 was injected with 42.5 g of 2-ethylhexyl acrylate, 42.2 g of styrene, and 0.30 g of 1,4-butanediol diacrylate as raw materials for a hydrophobic polymer and 302.6 g of ion exchanged water into a flask, and after increasing a temperature inside the system to 65° C., an initiator solution prepared by dissolving 876 mg of 2,2′-azobis[N-(2-carboxylethyl)-2-methylpropionamidine] tetrahydrate in 10.0 g of ion exchanged water was added thereto.

Polymerization was performed at the polymerization temperature of 65° C. for more than 12 hours, and a milky white dispersion was obtained.

This milky white dispersion was a liquid including Binder D for a non-aqueous electrolyte rechargeable battery.

This liquid was in a state that Binder D for a non-aqueous electrolyte rechargeable battery, in which a hydrophobic core formed of a hydrophobic polymer produced by copolymerization of 2-ethylhexyl acrylate, styrene, and 1,4-butanediol diacrylate as the raw materials for a hydrophobic polymer was covered with a hydrophilic shell formed of the water-soluble polymer, was stably dispersed in water.

The aqueous dispersion had a nonvolatile component of 19.0 wt %, which was measured after the reaction.

Thereafter, the reaction solution was concentrated by heating and depressurizing distillation to remove unreacted monomers, and then ammonia water and ion-exchange water were added to adjust the concentration of the solid content (e.g., amount) and the pH value, thereby obtaining an aqueous dispersion of Binder D for a non-aqueous electrolyte rechargeable battery having a solid content (e.g., amount) of 20 wt % and a pH value of 7.5 (Binder Composition D for a non-aqueous electrolyte rechargeable battery).

The obtained Binder Composition D for a non-aqueous electrolyte rechargeable battery, the aqueous dispersion with a solid content (e.g., amount) of 20 wt %, had 570 mPa·s of viscosity of at 25° C. and 30 rpm in a B-type (kind) viscometer.

### Synthesis of Binder E for Non-Aqueous Electrolyte Rechargeable Battery

157.89 g of the water-soluble copolymer aqueous solution having a concentration of the solid content (e.g., amount) of 9.5 wt % and a pH value of 7.5 was injected with 30.0 g of 2-ethylhexyl acrylate, 29.79 g of styrene, and 0.21 g of 1,4-butanediol diacrylate as raw materials for a hydrophobic polymer and 272.1 g of ion exchanged water into a flask, and after increasing a temperature inside the system to 65° C., an initiator solution prepared by dissolving 831 mg of 2,2′-azobis[N-(2-carboxylethyl)-2-methylpropionamidine] tetrahydrate in 10.0 g of ion exchanged water was added thereto.

Polymerization was performed at the polymerization temperature of 65° C. for more than 12 hours, and a milky white dispersion was obtained.

This milky white dispersion was a liquid including Binder E for a non-aqueous electrolyte rechargeable battery.

This liquid was in a state that Binder E for a non-aqueous electrolyte rechargeable battery, in which a hydrophobic polymer produced by copolymerization of 2-ethylhexyl acrylate, styrene, and 1,4-butanediol diacrylate added as the raw materials for the hydrophobic polymer was covered with the water-soluble polymer, was stably dispersed in water.

The aqueous dispersion had a nonvolatile component of 15.0 wt %, which was measured after the reaction.

Thereafter, the reaction solution was concentrated by heating and depressurizing distillation to remove unreacted monomers, and then ammonia water and ion-exchange water were added to adjust the solid content (e.g., amount) concentration and pH, thereby obtaining an aqueous dispersion of Binder E for a non-aqueous electrolyte rechargeable battery having a solid content (e.g., amount) of 15 wt % and a pH value of 7.5 (Binder Composition E for a non-aqueous electrolyte rechargeable battery).

The obtained Binder Composition E for a non-aqueous electrolyte rechargeable battery, the aqueous dispersion with a solid content (e.g., amount) of 15 wt %, had viscosity of 350 mPa·s at 25° C. and 30 rpm in a B-type (kind) viscometer.

### Synthesis of Binder F for Non-Aqueous Electrolyte Rechargeable Battery

270.68 g of the water-soluble polymer aqueous solution with a concentration of the solid content (e.g., amount) of 9.5 wt % and a pH value of 7.5 was injected with 30.0 g of 2-ethylhexyl acrylate, 29.79 g of styrene, and 0.21 g of 1,4-butanediol diacrylate as raw materials for a hydrophobic polymer and 230.6 g of ion exchanged water into a flask, and after increasing a temperature inside the system to 65° C., an initiator solution prepared by dissolving 773 mg of 2,2′-azobis[N-(2-carboxylethyl)-2-methylpropionamidine] tetrahydrate in 10.0 g of ion exchanged water was added thereto.

Polymerization was performed at the polymerization temperature of 65° C. for more than 12 hours, and a milky white dispersion was obtained.

This milky white dispersion was a liquid including Binder F for a non-aqueous electrolyte rechargeable battery.

This liquid was in a state that Binder F for a non-aqueous electrolyte rechargeable battery, in which a hydrophobic polymer produced by copolymerization of 2-ethylhexyl acrylate, styrene, and 1,4-butanediol diacrylate added as the raw materials for the hydrophobic polymer was covered with the water-soluble polymer, was stably dispersed in water.

The aqueous dispersion had a nonvolatile component of 15.0 wt %, which was measured after the reaction.

Thereafter, the reaction solution was concentrated by heating and depressurizing distillation to remove unreacted monomers, and then ammonia water and ion-exchange water were added to adjust the concentration of the solid content (e.g., amount) and the pH value, thereby obtaining an aqueous dispersion of Binder F for a non-aqueous electrolyte rechargeable battery having a solid content (e.g., amount) of 15 wt % and a pH value of 7.5 (Binder Composition F for a non-aqueous electrolyte rechargeable battery).

The obtained Binder Composition F for a non-aqueous electrolyte rechargeable battery, the aqueous dispersion with a solid content (e.g., amount) of 15 wt %, had 670 mPa·s at 25° C. and 30 rpm in a B-type (kind) viscometer.

### Synthesis of Binder Composition G for Non-Aqueous Electrolyte Rechargeable Battery

57.89 g of the water-soluble polymer aqueous solution having a concentration of the solid content (e.g., amount) of 9.5 wt % and a pH value of 7.5 was injected with 52.25 g of 2-ethylhexyl acrylate, 51.89 g of styrene, 0.36 g of 1,4-butanediol diacrylate as raw materials for a hydrophobic polymer, and 2.1 g of sodium dodecylbenzenesulfonate and 396.5 g of ion exchanged water into a flask, and after increasing a temperature inside the system to 65° C. into a flask, an initiator solution prepared by dissolving 942 mg of 2,2′-azobis[N-(2-carboxylethyl)-2-methylpropionamidine] tetrahydrate in 10.0 g of ion exchanged water was added thereto.

Polymerization was performed at the polymerization temperature of 65° C. for more than 12 hours, and a milky white dispersion was obtained.

This milky white dispersion was a liquid including Binder G for a non-aqueous electrolyte rechargeable battery.

This liquid was in a state that Binder G for a non-aqueous electrolyte rechargeable battery, in which a hydrophobic polymer produced by copolymerization of 2-ethylhexyl acrylate, styrene, and 1,4-butanediol diacrylate added as the raw materials for the hydrophobic polymer was covered with the water-soluble polymer, was stably dispersed in water.

The non-reactive surfactant (e.g., the above-described sodium dodecylbenzenesulfonate) was a surfactant having no polymerization reaction with the hydrophobic polymer and the water-soluble polymer forming the core and the shell of the binder.

The aqueous dispersion had a nonvolatile component of 19.6 wt %, which was measured after the reaction.

Thereafter, the reaction solution was concentrated by heating and depressurizing distillation to remove unreacted monomers, and then ammonia water and ion-exchange water were added thereto to adjust the concentration of the solid content (e.g., amount) and the pH value, thereby obtaining an aqueous dispersion of Binder G for a non-aqueous electrolyte rechargeable battery having a solid content (e.g., amount) of 20 wt % and a pH value of 7.5 (Binder Composition G for a non-aqueous electrolyte rechargeable battery).

The obtained Binder Composition G for a non-aqueous electrolyte rechargeable battery, the aqueous dispersion having a solid content (e.g., amount) of 20 wt %, had viscosity of 330 mPa·s at 25° C. and 30 rpm in a B-type (kind) viscometer.

### Synthesis of Binder Composition H for Non-Aqueous Electrolyte Rechargeable Battery

2.5 g of sodium dodecylbenzenesulfonate was injected with 50.0 g of 2-ethylhexyl acrylate, 49.6 g of styrene, and 0.4 g of 1,4-butanediol diacrylate as raw materials for a hydrophobic polymer and 390.0 g of ion exchanged water into a flask, and after increasing a temperature inside the system to 65° C., an initiator solution prepared by dissolving 896 mg of 2,2′-azobis[N-(2-carboxylethyl)-2-methylpropionamidine] tetrahydrate in 10.0 g of ion exchanged water was added thereto.

Polymerization was performed at the polymerization temperature of 65° C. for more than 12 hours, and a milky white dispersion was obtained.

This milky white dispersion was a liquid including Binder H for a non-aqueous electrolyte rechargeable battery.

This liquid was in a state that Binder H for a non-aqueous electrolyte rechargeable battery, in which a hydrophobic polymer produced by copolymerization of 2-ethylhexyl acrylate, styrene, and 1,4-butanediol diacrylate added as the raw materials for the hydrophobic polymer was covered with sodium dodecylbenzenesulfonate, a non-reactive surfactant, was stably dispersed in water.

The aqueous dispersion had a nonvolatile component of 20.3 wt %, which was measured after the reaction.

Thereafter, the reaction solution was concentrated by heating and depressurizing distillation to remove unreacted monomers, and then ammonia water and ion-exchange water were added thereto to adjust the concentration of the solid content (e.g., amount) and the pH value, thereby obtaining an aqueous dispersion of Binder H for a non-aqueous electrolyte rechargeable battery having a solid content (e.g., amount) of 20 wt % and a pH value of 7.5 (Binder Composition H for a non-aqueous electrolyte rechargeable battery).

The obtained Binder Composition H for a non-aqueous electrolyte rechargeable battery, the aqueous dispersion with a solid content (e.g., amount) of 20 wt %, had viscosity of 80 mPa·s at 25° C. and 30 rpm in a B-type (kind) viscometer.

### Measurement of Average Particle Diameter

Utilizing a wet laser diffraction scattering particle size analyzer, Mastersizer 3000E from Malvern Panalytical Ltd., the volume-weighted average particle diameter in ion exchanged water of the binder composition for non-aqueous electrolyte rechargeable batteries, adjusted to a concentration where the scattering intensity becomes 2%, was measured. The results are shown in Table 1 as follows.

TABLE 1

| | Binder composition (wt %) | | |
|---|---|---|---|
| | Hydrophilic | Hydrophobic | Average particle |
| Binder | shell | core | diameter (nm) |
| Binder A | 5 | 95 | 550 |
| Binder B | 5 | 95 | 350 |
| Binder C | 7.5 | 92.5 | 525 |
| Binder D | 10 | 90 | 510 |
| Binder E | 20 | 80 | 359 |
| Binder F | 30 | 70 | 354 |
| Binder G | 5 | 95 | 130 |
| Binder H | 0 | 100 | 231 |

### Example 1

Binder Composition A for a non-aqueous electrolyte rechargeable battery obtained as described above was utilized to manufacture a lithium-ion rechargeable battery cell in the following order.

### Manufacturing of Negative Electrode

A negative electrode mixture slurry was prepared by dispersing and mixing graphite, Binder Composition A for a non-aqueous electrolyte rechargeable battery, and sodium salt of carboxymethyl cellulose in a mass ratio of 97.2:2.0:0.8 in ion exchanged water, a solvent for a negative electrode slurry.

Subsequently, the negative electrode mixture slurry was applied to .g., simultaneously) sides (e.g., opposite sides) of a 10 μm-thick copper foil current collector to form a negative electrode mixture layer with a loading amount (areal density) of 12 mg/cm² per one side after coating by utilizing a roll coater and then, dried at 120° C. Then, the negative electrode mixture layer was roll-pressed to have density of 1.60 g/cc, manufacturing a double-sided negative electrode.

### Manufacturing of Positive Electrode

Li_{1.0}Ni_{0.88}Co_{0.1}Al_{0.01}Mg_{0.01}O₂, acetylene black, and polyvinylidene fluoride in a mass powder ratio of 97.7:1.0:1.3 were dispersed in N-methyl-2-pyrrolidone, a solvent for positive electrode slurry, preparing positive electrode slurry. Subsequently, the slurry was coated and dried on both surfaces (e.g., opposite surfaces) (e.g., simultaneously) of an aluminum foil as a current collector with a reverse roll coater to form a positive electrode mixture layer with a coating amount of 19.8 mg/cm² (areal density) and then, roll-pressed to have a mixture layer density of 3.70 g/cc, manufacturing a positive electrode.

### Manufacturing of Rechargeable Battery Cell

After respectively cutting the aforementioned negative and positive electrodes into each square of 29 mm×29 mm and 27 mm×27 mm, welding a nickel and aluminum lead wire thereonto, and interposing a polyethylene porous separator therebetween, 9 of the positive electrodes were stacked with 10 of the negative electrodes to manufacture an electrode stack.

Subsequently, after storing the electrode stack in an aluminum laminate film with the lead wires pulled out and injecting an electrolyte solution thereinto, the aluminum laminate film was sealed to manufacture a rechargeable battery cell before initial charge. Here, the electrolyte solution was prepared by dissolving 1M LiPF₆ and 1 wt % of vinylene carbonate in a solvent of ethylene carbonate/ethylmethyl carbonate/dimethyl carbonate mixed in 20/40/40 (a volume ratio), and an injection amount thereof was 1.25 g. The manufactured battery cell was designed to have capacity of 500 mAh.

For example, in the synthesis of Binder A for non-aqueous electrolyte rechargeable batteries, a water-soluble polymer aqueous solution was combined with 2-ethylhexyl acrylate, styrene, and 1,4-butanediol diacrylate to form a hydrophobic polymer core, which was then covered with a hydrophilic shell. The resulting aqueous dispersion had a solid content of 20 wt % and a pH of 7.5. This binder was used to create a negative electrode mixture slurry, which was applied to a copper foil current collector and dried to form a double-sided negative electrode. Positive electrodes were similarly prepared using a different slurry composition. The electrodes were assembled into a rechargeable battery cell with an electrolyte solution, resulting in a battery designed to have a capacity of 500 mAh.

### Example 2

A rechargeable battery cell was manufactured in substantially the same manner as in Example 1 except that Binder Composition B for a non-aqueous electrolyte rechargeable battery was utilized instead of Binder Composition A for a non-aqueous electrolyte rechargeable battery.

### Example 3

A rechargeable battery cell was manufactured in substantially the same manner as in Example 1 except that Binder Composition C for a non-aqueous electrolyte rechargeable battery was utilized instead of Binder Composition A for a non-aqueous electrolyte rechargeable battery.

### Example 4

A rechargeable battery cell was manufactured in substantially the same manner as in Example 1 except that Binder Composition D for a non-aqueous electrolyte rechargeable battery was utilized instead of Binder Composition A for a non-aqueous electrolyte rechargeable battery.

### Comparative Example 1

A rechargeable battery cell was manufactured in substantially the same manner as in Example 1 except that Binder Composition E for a non-aqueous electrolyte rechargeable battery was utilized instead of Binder Composition A for a non-aqueous electrolyte rechargeable battery.

### Comparative Example 2

A rechargeable battery cell was manufactured in substantially the same manner as in Example 1 except that Binder Composition F for a non-aqueous electrolyte rechargeable battery was utilized instead of Binder Composition A for a non-aqueous electrolyte rechargeable battery.

### Comparative Example 3

A rechargeable battery cell was manufactured in substantially the same manner as in Example 1 except that Binder Composition G for a non-aqueous electrolyte rechargeable battery was utilized instead of Binder Composition A for a non-aqueous electrolyte rechargeable battery.

### Comparative Example 4

A rechargeable battery cell was manufactured in substantially the same manner as in Example 1 except that Binder Composition H for a non-aqueous electrolyte rechargeable battery was utilized instead of Binder Composition A for a non-aqueous electrolyte rechargeable battery.

### Comparative Example 5

A rechargeable battery cell was manufactured in substantially the same manner as in Example 1 except that a modified styrene butadiene rubber (hereinafter, referred to as SBR) was utilized instead of Binder Composition A for a non-aqueous electrolyte rechargeable battery.

### Evaluation of Negative Electrode and Rechargeable Battery Cell

### Peel Strength of Negative Electrode

Each of the negative electrodes of Examples 1 to 4 and Comparative Examples 1 to 5 before and after the roll-pressing was cut into a rectangular shape with a width of 25 mm and a length of 100 mm. Subsequently, an active material side thereof was attached to a stainless-steel plate by utilizing a double-sided adhesive tape, preparing samples for evaluating negative electrode peel strength. The samples were mounted on a peeling tester (SHIMAZU EZ-S manufactured by Shimadzu Corp.) to measure 180° peel strength. The results are shown in Table 2.

### DC Resistance

The rechargeable battery cells according to Examples 1 to 4 and Comparative Examples 1 to 5 were constant current-charged to 4.25 V with design capacity of 0.1 CA and continuously, constant voltage-charged to 4.25 V until it reached 0.05 CA in a thermostat at 25° C. Subsequently, the cells were constant current-discharged to 2.8 V with 0.1 CA. In addition, the cells were two cycles constant current-charged with 0.2 CA, and constant voltage-charged with 0.05 CA and then, constant current-discharged with 0.2CA under conditions of a charge cut-off voltage of 4.25 V and a discharge cut-off voltage of 2.8 V in the thermostat at 25° C.

Then, these rechargeable battery cells were constant current-charged with 0.2 CA to charge capacity of 50% and then, constant current-discharged with each current of 0.2 CA, 0.5 CA, 1 CA, and 2 CA respectively for 10 seconds at 25° C., which were plotted on a horizontal axis for a current after 10 seconds and on a vertical axis for a voltage.

The obtained plots were utilized to draw a straight line through linear approximation, of which a slope was regarded as resistance. The results are shown in Table 2.

### Evaluation of Peeling of Negative Electrode Mixture Layer after Initial Charging

The rechargeable battery cells of Examples 1 to 4 and Comparative Examples 1 to 5 were constant current-charged to 4.25 V with design capacity of 0.1 CA and continuously, constant voltage-charged to 4.25 V with 0.05 CA in the thermostat at 25° C. Subsequently, the rechargeable battery cells were disassembled in a dry room to examine and evaluate states of the negative electrodes with naked eyes according to the following criteria. The results are shown in Table 2.
0: No peeling of the negative electrode mixture layer on the copper foil
x: Peeling of the negative electrode mixture layer on the copper foil

TABLE 2

| | | | | Peeling of the |
|---|---|---|---|---|
| | | Negative | | negative |
| | | electrode | | electrode |
| | | peel | | mixture layer |
| | | strength | Resistance | after initial |
| | Binder | (gf/mm) | (mΩ) | charging |
| Example 1 | Binder A | 2.1 | 90 | ○ |
| Example 2 | Binder B | 2.0 | 91 | ○ |
| Example 3 | Binder C | 1.9 | 91 | ○ |
| Example 4 | Binder D | 1.8 | 92 | ○ |
| Comparative Example 1 | Binder E | 0.9 | 95 | ○ |
| Comparative Example 2 | Binder F | 1.3 | 96 | ○ |
| Comparative Example 3 | Binder G | 1.3 | 95 | ○ |
| Comparative Example 4 | Binder H | 1.0 | 93 | × |
| Comparative Example 5 | SBR | 1.7 | 101 | ○ |

### Consideration of Results of Examples and Comparative Examples

Comparing Examples 1 to 4 with Comparative Examples 1 to 4 of Table 2, Examples 1 to 4, in which the binder compositions for a non-aqueous electrolyte rechargeable battery had a water-soluble polymer within a content (e.g., amount) range of 3 to 10 wt %, and the binders for a non-aqueous electrolyte rechargeable battery was adjusted to have an average particle diameter of greater than or equal to about 250 nm, exhibited greatly improved peel strength of the negative electrode mixture layer from the negative electrode current collector and also, improved battery resistance, compared to the comparative examples.

For example, comparing Comparative Examples 3 and 4, a binder for a non-aqueous electrolyte rechargeable battery, which was synthesized by utilizing a low molecular emulsifier, a non-reactive surfactant in addition to or instead of the water-soluble polymer, turned out to be likely a small average particle diameter. Compared with Examples 1 to 4, peel strength and resistance were deteriorated. As a result, as in Examples 1 to 4, it was suitable to prepare a binder for a non-aqueous electrolyte rechargeable battery by not adding a non-reactive surfactant, and it may be considered to be suitable to prepare the binder for a non-aqueous electrolyte rechargeable battery by not substantially including the non-reactive surfactant.

In one or more embodiments, if (e.g., when) a water-soluble polymer in a binder for a non-aqueous electrolyte rechargeable battery and in a binder composition for a non-aqueous electrolyte rechargeable battery was adjusted to a content (e.g., amount) of 3 to 10%, and a particle diameter of the binder for a non-aqueous electrolyte rechargeable battery was increased, a negative electrode mixture layer and a negative electrode current collector were more likely bonded by an anchor effect if (e.g., when) pressed.

In addition, a binder with a large particle diameter for a non-aqueous electrolyte rechargeable battery reduced the number of binder particles for a non-aqueous electrolyte rechargeable battery in the negative electrode mixture layer and thus made inhibition of ion conductivity in the negative electrode mixture layer small as much as possible, thereby reducing resistance in a negative electrode.

Accordingly, it may be considered that the larger particle diameter of the binder for a non-aqueous electrolyte rechargeable battery, the better, but it was confirmed that a suitable particle diameter of the binder for a non-aqueous electrolyte rechargeable battery might be in a range of less than or equal to about 1000 nm in terms of suppressing or reducing agglomeration of the particles.

In addition, compared to styrene butadiene rubber (SBR) (Comparative Example 5), e.g., a binder for a non-aqueous electrolyte rechargeable battery utilized in Comparative Example 5, the non-aqueous electrolyte rechargeable battery cells of Examples 1 to 4 exhibited equivalent or higher peel strength of a negative electrode mixture layer from a negative electrode current collector and reduced resistance, compared to the cases of utilizing SBR. For example, various examples and comparative examples were tested to evaluate the performance of the binder compositions. The results showed that binders with a water-soluble polymer content of 3-10% and an average particle diameter of at least 250 nm exhibited improved peel strength and reduced battery resistance compared to those synthesized with low molecular emulsifiers or non-reactive surfactants. Larger particle diameters in the binder reduced the number of binder particles in the negative electrode mixture layer, enhancing ion conductivity and reducing resistance. The enhanced particle diameter was found to be less than or equal to 1000 nm to prevent agglomeration. Compared to comparable styrene butadiene rubber (SBR) binders, the new binder compositions demonstrated equivalent or superior peel strength and reduced resistance.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery manufacturing device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

A person of ordinary skill in the art, in view of the present disclosure in its entirety, would appreciate that each suitable feature of the embodiments of the present disclosure may be combined or combined with each other, partially or entirely, and may be technically interlocked and operated in one or more suitable ways, and each embodiment may be implemented independently of each other or in conjunction with each other in any suitable manner unless otherwise stated or implied.

While this disclosure has been described in connection with what are presently considered to be practical one or more embodiments of the present disclosure, it is to be understood that the disclosure is not limited to the disclosed one or more embodiments. In contrast, it is intended to cover one or more suitable modifications and equivalent arrangements included within the spirit and scope of the appended claims and equivalents thereof.

What is claimed is:

1. A binder comprising
a particle-shaped binder having a core-shell structure comprising a hydrophobic core and a hydrophilic shell,
wherein
the hydrophobic core comprises at least one selected from among a derivative from an aromatic vinyl monomer, a derivative from an unsaturated carboxylic acid alkyl ester monomer, a derivative from a (meth)acrylic acid monomer, and a derivative from an unsaturated carboxylic acid amide monomer,
the hydrophilic shell comprises at least one selected from among a derivative from a (meth)acrylic acid monomer, a derivative from a sodium styrene sulfonate monomer, and a derivative from a (meth)acrylonitrile monomer,
an amount of the hydrophobic core is greater than or equal to about 90 wt % and less than or equal to about 97 wt % based on 100 wt % of the binder,
an amount of the hydrophilic shell is greater than or equal to about 3 wt % and less than or equal to about 10 wt % based on 100 wt % of the binder, and
an average particle size of the binder measured by a wet laser diffraction scattering method is greater than or equal to about 250 nm and less than or equal to about 1000 nm, and
wherein the binder is a binder for a non-aqueous electrolyte rechargeable battery.

2. The binder as claimed in claim 1, wherein
the hydrophilic shell comprises a water-soluble polymer,
the water-soluble polymer comprises at least one selected from the derivative from the (meth)acrylic acid monomer, the derivative from the sodium styrene sulfonate monomer, and the derivative from the (meth)acrylonitrile monomer, and
in the water-soluble polymer, based on 100 wt % of the water-soluble polymer an amount of the derivative from the (meth)acrylic acid monomer is
greater than or equal to about 10 wt % and less than or equal to about 50 wt %, an amount of the derivative from the sodium styrene sulfonate monomer
is greater than or equal to about 10 wt % and less than or equal to about 50 wt %, and
an amount of the derivative from (meth)acrylonitrile monomer is greater than or equal to about 10 wt % and less than or equal to about 50 wt %.

3. The binder as claimed in claim 2, wherein
a molecular weight of the water-soluble polymer is about 300,000 to about 2,000,000.

4. The binder as claimed in claim 1, wherein
the hydrophobic core comprises a hydrophobic polymer comprising at least one selected from among the derivative from an aromatic vinyl monomer, the derivative from an unsaturated carboxylic acid alkyl ester monomer, the derivative from a (meth)acrylic acid monomer, and a derivative from an unsaturated carboxylic acid amide monomer.

5. The binder as claimed in claim 1, wherein
the hydrophobic core is chemically bonded to the hydrophilic shell.

6. The binder as claimed in claim 1, wherein
a non-reactive surfactant is not added.

7. A binder composition comprising
the binder as claimed in claim 1; and
an aqueous solvent,
wherein the binder composition is a binder composition for a non-aqueous electrolyte rechargeable battery.

8. A negative electrode slurry comprising
the binder composition as claimed in claim 7; and
a negative electrode active material,
wherein the negative electrode slurry is a negative electrode slurry for a non-aqueous electrolyte rechargeable battery.

9. A negative electrode comprising
the binder as claimed in claim 1; and
a negative electrode active material,
wherein the negative electrode is a negative electrode for a non-aqueous electrolyte rechargeable battery.

10. The negative electrode as claimed in claim 9, wherein
a water-soluble polymer compound is further included.

11. The negative electrode as claimed in claim 10, wherein
the water-soluble polymer compound is an alkali metal salt of carboxymethyl cellulose.

12. A non-aqueous electrolyte rechargeable battery, comprising
the negative electrode as claimed in claim 9.

13. A method comprising
preparing a particle-shaped binder having a core-shell structure comprising a hydrophobic core and a hydrophilic shell,
synthesizing a hydrophobic polymer constituting the hydrophobic core in a presence of a water-soluble polymer constituting the hydrophilic shell,
wherein the water-soluble polymer comprises at least one selected from among a derivative from a (meth)acrylic acid monomer, a derivative from a sodium styrene sulfonate monomer, and a derivative from a (meth)acrylonitrile monomer, and
wherein the method is a method for preparing a binder for a non-aqueous electrolyte rechargeable battery.

14. The method as claimed in claim 13, wherein
in the synthesizing of the hydrophobic polymer, one or more monomers selected from among an aromatic vinyl monomer, an unsaturated carboxylic acid alkyl ester monomer, a (meth)acrylic acid monomer, and an unsaturated carboxylic acid amide monomer are polymerized to synthesize the hydrophobic polymer.

15. The method as claimed in claim 13, wherein
an amount of the hydrophobic core is greater than or equal to about 90 wt % and less than or equal to about 97 wt % based on 100 wt % of the binder, and an amount of the hydrophilic shell is greater than or equal to about 3 wt % and less than or equal to about 10 wt % based on 100 wt % of the binder.

16. The method as claimed in claim 13, wherein
an average particle size of the binder measured by a wet laser diffraction scattering method is greater than or equal to about 250 nm and less than or equal to about 1000 nm.
